(19) United States
(12) Patent Application Publication
(10) Pub. No.: US 2026/0180430 A1
(43) Pub. Date: Jun. 25, 2026

(54) LOW-VOLTAGE PROTECTIVE ARRANGEMENT

(71) Applicant: EATON INTELLIGENT POWER LIMITED, Dublin 4 (IE)

(72) Inventor: Kenan ASKAN, Vienna (AT)

(21) Appl. No.: 18/845,091

(22) PCT Filed: Mar. 23, 2023
(86) PCT No.: PCT/EP2023/025130

§ 371 Date: Sep. 9, 2024

(30) Foreign Application Priority Data
Mar. 24, 2022 (GB) 2204176.8

(51) Int. Cl. H02M 1/32

(52) U.S. Cl. CPC H02M 1/32

(57) ABSTRACT

Some embodiments relate to a low-voltage protective arrangement comprising a low-voltage protective device and a power supply network, with the low-voltage protective device comprises at least one outer conductor path with an outer conductor power supply connection, a mechanical bypass relay arranged in the outer conductor path, a first semiconductor circuit arrangement connected in parallel to the mechanical bypass relay, a control and driver unit configured to drive the first semiconductor circuit arrangement, the power supply network comprises a first inductor connected to the outer conductor power supply connection, it is suggested, that the control and driver unit comprises a first and a second power supply connection, that the first and the second power supply connection are connected—at least indirectly—with the power supply network in parallel to the first inductor.

### CROSS-REFERENCE TO RELATED APPLICATIONS

This application is a national phase filing under 35 C.F.R. § 371 of and claims priority to PCT Patent Application No. PCT/EP2023/025130, filed on Mar. 23, 2023, which claims the priority benefit under 35 U.S.C. § 119 of British Patent Application No. 2204176.8, filed on Mar. 24, 2022, the contents of which are hereby incorporated in their entireties by reference.

### TECHNICAL FIELD

The present disclosure relates to a low-voltage protective arrangement according to the generic part of claim 1.

### BACKGROUND

Modern protective devices often use semiconductors and μC to drive them. In their functionality, these protective devices often have higher performance and are more effective, that completely mechanic circuit breakers. But these modern protective devices need a power supply, which is separately connected with a network.

In a lot of countries, it is not allowed that a protective device needs an auxiliary power supply connection.

### SUMMARY OF THE DISCLOSURE

It is an object of the presently disclosed subject matter to overcome the drawbacks of the state of the art by providing a low-voltage protective device that does not require a power supply.

According to the presently disclosed subject matter, the aforementioned object is solved by the features of claim 1.

As a result, the low-voltage protective device can work completely without a power supply or a separately power connection. Therefore, it is possible to use this kind of protective device also in countries in which only voltage independent protective devices are allowed. The control and driver unit and the low-voltage protective device have the same triggering ability as protective devices with additional power supply.

### BRIEF DESCRIPTION OF THE FIGURES

The presently disclosed subject matter is described with reference to the drawings. The drawings show only exemplary embodiments of the presently disclosed subject matter.

FIG. 1 shows a first preferred embodiment of a low-voltage protective arrangement; and

FIG. 2 shows a preferred embodiment of a connection of the control and driver unit and the power supply network.

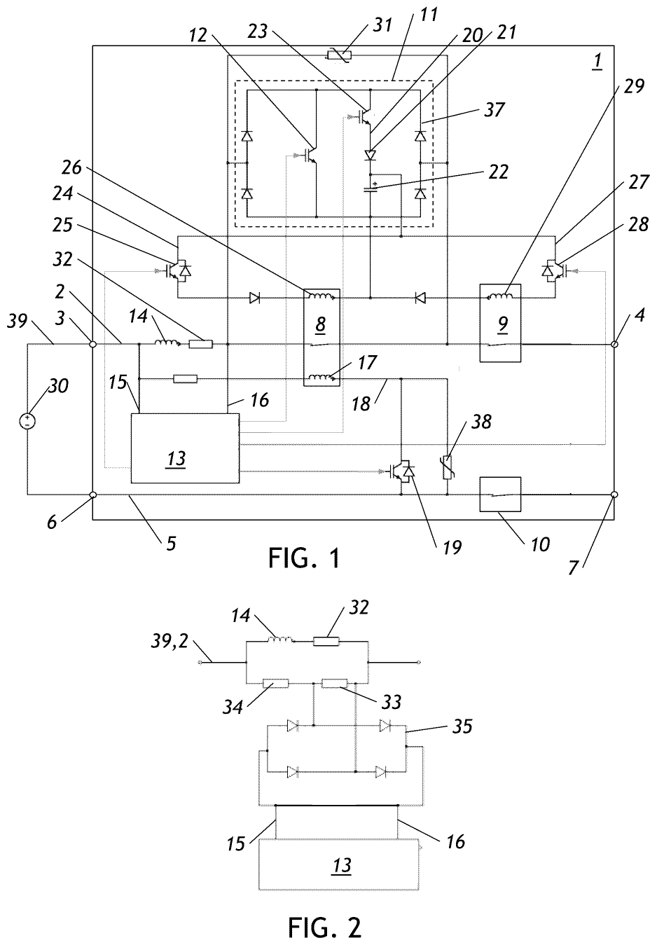

FIGS. 1 and 2 illustrates a preferred embodiment of a low-voltage protective arrangement comprising a low-voltage protective device 1 and a power supply network,
the low-voltage protective device 1 comprises:
at least one outer conductor path 2 from an outer conductor power supply connection 3 of the low-voltage protective device 1 to an outer conductor load connection 4 of the low-voltage protective device 1,
a neutral conductor path 5 from a first neutral conductor terminal 6 of the low-voltage protective device 1 to a second neutral conductor terminal 7 of the low-voltage protective device 1,
a mechanical bypass relay 8 arranged in the outer conductor path 2,
a first semiconductor circuit arrangement 11 connected in parallel to the mechanical bypass relay 8, the first semiconductor circuit arrangement 11 comprising at least a first semiconductor 12,
a control and driver unit 13 configured to drive the first semiconductor circuit arrangement 11 with a control voltage,
the power supply network comprises at least a first inductor 14, the first inductor 14 is connected to the outer conductor power supply connection 3,
the control and driver unit 13 comprises a first power supply connection 15 and a second power supply connection 16, that the first and the second power supply connection 15, 16 are connected—at least indirectly—with the power supply network in parallel to the first inductor 14.

### DETAILED DESCRIPTION

As a result, the low-voltage protective device 1 can work completely without a power supply or a separately power connection. Therefore, it is possible to use this kind of protective device also in countries in which only voltage independent protective devices are allowed. The control and driver unit 13 and the low-voltage protective device 1 have the same triggering ability as protective devices with additional power supply.

The present low-voltage protective device 1 is preferably a low-voltage hybrid circuit breaker (HCB) for DC. The basic functionality of a hybrid circuit breaker is described in WO 2015/028634 A1. Low voltage is, as usual, in the range up to 1000V AC and/or 1500V DC.

The low-voltage protective device 1 can be integrated in another electric device or it can be a separated device with an own casing.

The low-voltage protective device 1 comprises at least one respectively a first outer conductor path 2 from a first outer conductor terminal 3 of the low-voltage protective device 1 to a second outer conductor terminal 4 of the low-voltage protective device 1. In case of a three-phase AC-network, the low-voltage protective device 1 also comprises a second and a third outer contact path. For a DC network with two different voltage parts of the power supply network, the low-voltage protective device 1 also would have two outer contact paths.

The low-voltage protective device 1 comprises a neutral conductor path 5 from a first neutral conductor terminal 6 of the low-voltage protective device 1 to a second neutral conductor terminal 7 of the low-voltage protective device 1.

FIG. 1 shows the low-voltage protective arrangement comprising the low-voltage protective device 1 and the power supply network 39. In FIG. 1 the low-voltage protective device 1 is connected to the power supply network 39. The power supply network 39 comprise in this picture an electric source 30.

The power supply network 39 comprises a first inductor 14. Another name of the first inductor 14 is short circuit choke or fault current limiting air core inductor. Preferably the inductance value of the first inductor 14 is about 150 to 250 μH.

In the preferred embodiment according FIG. 1 the first inductor 14 is part of the low-voltage protective device 1, and is arranged in the outer conductor path 2. The first inductor 14 could also be placed in the power supply network 39 outside the low-voltage protective device 1.

The low-voltage protective device 1 preferably comprises a current measuring device arranged in the first outer conductor path 2. This is not shown in FIG. 1.

The low-voltage protective device 1 comprises a mechanical bypass relay 8 arranged in the outer conductor path 2. The mechanical bypass relay 8 comprises an opening coil 17 and a closing coil 26. The mechanical bypass relay 8 is-indirectly-controlled by a control and driver unit 13 of the low-voltage protective device 1.

The low-voltage protective device 1 comprises a first semiconductor circuit arrangement 11 connected in parallel to the mechanical bypass relay 8. The first semiconductor circuit arrangement 11 comprises at least a first semiconductor 12. Preferably the first semiconductor 12 is a power semiconductor, especially an IGBT. The first semiconductor 12 is controlled by the control and driver unit 13 of the low-voltage protective device 1.

According to the preferred embodiment, the first semiconductor circuit arrangement 11 comprises a second conductor path 20 arranged in parallel to the first semiconductor 12. This second conductor path 20 comprises at least a first diode 21 and a first capacitor 22 arranged in series in the second conductor path 20. The first capacitor 22 is preferably an electrolytic capacitor.

To control the second conductor path 20, especially to control a loading of the first capacitor 22, a third semiconductor 23 is preferably arranged in series to the first diode 21 and the first capacitor 22 in the second conductor path 20. The first capacitor 22 can store parts of the electric energy caused by the first inductance 14. Preferably the first capacitor has a capacitor value higher than 0.1 F, especially higher than 0.5 F, preferably higher than 1 F. The third semiconductor 23 is controlled by and connected with the control and driver unit 13 of the low-voltage protective device 1. The third semiconductor 23 is especially used to avoid a charging of the first capacitor 22 by an inrush current caused by a normal respectively usually switching-on process. The diode 21 prevents a discharging of the first capacitor 22 when the first semiconductor 12 is switched on.

According to the illustrated preferred embodiment, the first semiconductor circuit arrangement 11 is connected with a first rectifier 37 to the outer conductor path 2. The first rectifier 37 allows a bidirectional current flow in the low-voltage protective device 1.

According to the preferred embodiments of the low-voltage protective device 1 a first varistor 31, especially embodied as MOV, is connected parallel to the first semiconductor circuit arrangement 11.

The low-voltage protective device 1 comprises a control and driver unit 13 configured to drive respectively control at least the first semiconductor circuit arrangement 11 and preferably further transistors respectively semiconductors 19, 23, 25, 28 of the low-voltage protective device 1. The control and driver unit 13 is connected to each of these parts to communicate with them. Preferably the control and driver unit 13 comprises a PROM, PLA, FPGA and/or a μC.

As explained, the varistor 14 can be arranged outside the low-voltage protective device 1 or inside and as part of the low-voltage protective device 1. If the varistor 14 is part of the low-voltage protective device 1, the inductor 14 is arranged in the outer conductor path 2 between the outer conductor power supply connection 3 and the first semiconductor circuit arrangement 11 respectively the mechanical bypass relay 8. FIG. 1 shows also a resistance 32 arranged in series to the inductor 14. This is the internal resistance of the inductor 14. The inductor 14 reduce ascending gradient of an increase of a fault current. In case of an overcurrent or another high fault current, this voltage drop is high enough the power supply the control and driver unit 13.

The control and driver unit 13 comprises a first power supply connection 15 and a second power supply connection 16. Neither of these power supply connections 15, 16 is connected with a special power supply device and/or with the outer conductor path 2 and the neutral conductor path 5. Instead of this, both power supply connections 15, 16, therefore the first power supply connection 15 and the second power supply connection 16, are—at least indirectly—connected with different parts of the outer conductor path 2. The first power supply connection 15 connects—at least indirectly—the outer conductor path 2 between the outer conductor power supply connection 3 and the first inductor 14. The second power supply connection 16 connects—at least indirectly—the outer conductor path 2 between the first inductor 14 and the connection of the first semiconductor circuit arrangement 11 respectively the mechanical bypass relay 8. Therefore, the control and driver unit 13 is connected—at least indirectly—in parallel to the first inductor 14.

FIG. 1 shows a direct connection of the first and the second power supply connection 15, 16 with the outer conductor path 2. It has been shown that in case of typical high currents of thousand amperes or more, especially caused by a short circuit, the voltage drops at the first inductor 14 is up to more than 500 V. Normally the voltage drop is about 700 V. Such a high voltage could be too much for the control and driver unit 13. According to a preferred embodiment, the outer conductor path 2 comprises a resistor-arrangement connected in parallel to the first inductor 14. This arrangement is illustrated or shown in FIG. 2. The resistor-arrangement comprises a first resistor 33 and a second resistor 34. The second resistor 34 is arranged in series to the first resistor 33. The resistor-arrangement respectively the two resistors 33, 34 build the second part of a parallel switching arrangement. The first part of this parallel switching arrangement is the first inductor 14. The voltage drop at the resistor-arrangement is the same as the voltage drop at the first inductor 14. But the voltage at the first resistor 33 is lower, and the dimension of the limitation of the voltage is adjustable by the resistance ratio of the first and the second resistor 33, 34. According to the preferred embodiment and as illustrated in FIG. 2, the control and driver unit 13 is connected in parallel to the first resistor 33.

According to the preferred embodiment and as illustrated in FIG. 2 in the connection arrangement of the control and driver unit 13 to the first resistor 33, a second rectifier 35 is arranged, to enable bidirectional use of the low-voltage protective device 1.

The energy of high currents in the outer conductor path 2 is not only used for powering the control and driver unit 13, it is also stored in the first capacitor 22. That is used for switching-off operations of the low-voltage protective device 1 are driven by this electric energy as power supply.

The mechanical bypass relay 8 comprises an opening coil 17 respectively a mechanical bypass relay-opening coil 17. According to the preferred embodiment, and as illustrated in FIG. 1, the opening coil 17 is arranged in a first conductor path 18 of the low-voltage protective device 1. This first conductor path 18 is connected with the outer conductor path 2 on one side and to the neutral conductor path 5 on the other side. The first conductor path 18 connects the outer conductor path 2 between the outer conductor power supply connection 3 and the first inductor 14.

A second semiconductor 19 is arranged in the first conductor path 18, preferably with an anti-parallel or freewheeling diode. Preferably a second varistor 38 is arranged parallel to the second semiconductor 19. The second semiconductor 19 is connected to and controlled by the control and driver unit 13. As the first conductor path 18 is connected with the outer conductor path 2 and the neutral conductor path 5 it is connected with the power supply network 39.

One of the first steps of the switching-off process of a hybrid circuit breaker, especially the low-voltage protective device 1, is the switching-off of the mechanical bypass relay 8. Details of the functionality of a hybrid circuit breaker are described in WO 2015/028634 A1.

Especially the low-voltage protective device 1 comprises at least a first galvanic separation relay 9 arranged in the outer conductor path 2, which is typically for a hybrid circuit breaker. The first galvanic separation relay 9 comprises a galvanic separation relay-opening coil 29. Further, the low-voltage protective device 1 preferably comprises a second galvanic separation relay 10 arranged in the neutral conductor path 5. This second galvanic separation relay 10 will also comprise a galvanic separation relay-opening coil, which is not shown in FIG. 1.

According to a preferred embodiment the low-voltage protective device 1 comprises a fourth conductor path 27 and a fifth semiconductor 28. The fifth semiconductor 28 and the galvanic separation relay-opening coil 29 are arranged in series in the fourth conductor path 27. Parts of the fourth conductor path 27 are connecting the first capacitor 22. The first capacitor 22 is also part of the fourth conductor path 27. The fifth semiconductor 28 is controlled by the control and driver unit 13. Switching-on the fifth semiconductor 28 activates the galvanic separation relay-opening coil 29. The energy is supplied by the first capacitor 22. If the low-voltage protective device 1 would also comprise a second galvanic separation relay 10, a galvanic separation relay-opening coil of the second galvanic separation relay 10 would also be arranged in the fourth conductor path 27.

Preferably, the low-voltage protective device 1 does not comprise an arrangement for closing open galvanic separation relays 9, 10. Preferably the open galvanic separation relays 9, 10 should be closed by hand by a human being.

According to the special embodiment, the low-voltage protective device 1 comprises a third conductor path 24 and a fourth semiconductor 25. The fourth semiconductor 25 and a closing coil 26 of the mechanical bypass relay 8 are arranged in series in the third conductor path 24. Parts of the third conductor path 24 are connecting the first capacitor 22. The first capacitor 22 is also part of the third conductor path 24. The fourth semiconductor 25 is controlled by the control and driver unit 13. Switching-on the fourth semiconductor 25 activates the closing coil 26. The energy is supplied by the first capacitor 22, and to close the mechanical bypass relay 8.

While the presently disclosed subject matter has been particularly shown and described with reference to exemplary embodiments thereof, it will be understood by those skilled in the art that various changes in form and details may be made therein without departing from the spirit and scope of the presently disclosed subject matter as defined by the appended claims. The exemplary embodiments should be considered as descriptive only and not for purposes of limitation. Therefore, the scope of the presently disclosed subject matter is not defined by the detailed description but by the appended claims.

Hereinafter are principles for understanding and interpreting the actual disclosure.

Features are usually introduced with an indefinite article “one, a, an”. Unless otherwise stated in the context, therefore, “one, a, an” is not to be understood as a numeral.

The conjunction “or” has to be interpreted as inclusive and not as exclusive, unless the context dictates otherwise. “A or B” also includes “A and B”, where “A” and “B” represent random features.

By means of an ordering number word, for example “first”, “second” or “third”, in particular a feature X or an object Y is distinguished in several embodiments, unless otherwise defined by the disclosure of the presently disclosed subject matter. In particular, a feature X or object Y with an ordering number word in a claim does not mean that an embodiment of the presently disclosed subject matter covered by this claim must have a further feature X or another object Y.

An “essentially” in conjunction with a numerical value includes a tolerance of ±10% around the given numerical value, unless the context dictates otherwise.

For ranges of values, the endpoints are included, unless the context dictates otherwise.

1. Low-voltage protective arrangement comprising a low-voltage protective device (1) for use with a power supply network, wherein the low-voltage protective device comprises:
at least one outer conductor path from an outer conductor power supply connection of the low-voltage protective device to an outer conductor load connection of the low-voltage protective device,
a neutral conductor path from a first neutral conductor terminal of the low-voltage protective device to a second neutral conductor terminal of the low-voltage protective device,
a mechanical bypass relay arranged in the outer conductor path,
a first semiconductor circuit arrangement connected in parallel to the mechanical bypass relay, the first semiconductor circuit arrangement comprising at least a first semiconductor,
a control and driver unit configured to drive the first semiconductor circuit arrangement with a control voltage to indirectly control the mechanical bypass relay,
a first inductor arranged in the outer conductor path,
wherein, that
the control and driver unit comprises a first power supply connection and a second power supply connection, that the first and the second power supply connection are connected—at least indirectly—with the power supply network in parallel to the first inductor.

2. Low-voltage protective arrangement according to claim 1, wherein, that the mechanical bypass relay comprises an opening coil, that the opening coil is arranged in a first conductor path from the outer conductor path to the neutral conductor path, that a second semiconductor is arranged in the first conductor path, and that the second semiconductor is connected to the control and driver unit.

3. Low-voltage protective arrangement according to claim 2, wherein, that the first conductor path connects to the outer conductor path between the outer conductor power supply connection and the first inductor.

4. Low-voltage protective arrangement according to claim 1, wherein, that the first semiconductor circuit arrangement comprises a second conductor path arranged in parallel to the first semiconductor, and that a first diode and a first capacitor are arranged in series in the second conductor path.

5. Low-voltage protective arrangement according to claim 4, wherein, that a third semiconductor is arranged in series to the first diode and the first capacitor in the second conductor path, and that the control and driver unit is connected with the third semiconductor.

6. Low-voltage protective arrangement according to claim 4, wherein, that the low-voltage protective device comprises a third conductor path, that a fourth semiconductor and a closing coil of the mechanical bypass relay are arranged in series in the third conductor path, and that the first capacitor is part of the third conductor path.

7. Low-voltage protective arrangement according to claim 1, wherein, that the low-voltage protective device comprises at least a first galvanic separation relay arranged in the outer conductor path.

8. Low-voltage protective arrangement according to claim 4, wherein, that the low-voltage protective device comprises a fourth conductor path, that a fifth semiconductor and a galvanic separation relay-opening coil of the first galvanic separation relay are arranged in series in the fourth conductor path, and that the first capacitor is part of the fourth conductor path.

9. Low-voltage protective arrangement according to claim 1, wherein, that the low-voltage protective device comprises a resistor-arrangement connected in parallel to the first inductor, that the resistor-arrangement comprises a first resistor and a second resistor, and that the control and driver unit is connected in parallel to the first resistor.

10. Low-voltage protective arrangement according to claim 1, wherein, that the first inductor is part of the low-voltage protective device, and is arranged in the outer conductor path, and that the first and the second power supply connection are connected with the outer conductor path.
